(19) United States
(12) Patent Application Publication
(10) Pub. No.: US 2023/0224737 A1
(43) Pub. Date: Jul. 13, 2023

(54) INFORMATION PROCESSING METHOD, INFORMATION PROCESSING DEVICE, WIRELESS COMMUNICATION SYSTEM, AND INFORMATION PROCESSING PROGRAM

(71) Applicant: NIPPON TELEGRAPH AND TELEPHONE CORPORATION, Tokyo (JP)

(72) Inventors: Toshiro NAKAHIRA, Musashino-shi, Tokyo (JP); Hirantha ABEYSEKERA, Musashino-shi, Tokyo (JP); Koichi ISHIHARA, Musashino-shi, Tokyo (JP); Takatsune MORIYAMA, Musashino-shi, Tokyo (JP)

(73) Assignee: NIPPON TELEGRAPH AND TELEPHONE CORPORATION, Tokyo (JP)

(21) Appl. No.: 18/008,724

(22) PCT Filed: Jun. 8, 2020
(86) PCT No.: PCT/JP2020/022571

§ 371 Date: Dec. 7, 2022

(51) Int. Cl. H04W 24/08

(52) U.S. Cl. CPC H04W 24/08

(57) ABSTRACT

An information processing method includes: an association step of associating pieces of wireless signal information that are respectively transmitted by a plurality of base stations and are measured at a plurality of measurement positions with cells of the base stations, for each of the measurement positions; and an interference calculation step of calculating interference between cells of the plurality of base stations based on the pieces of wireless signal information associated with the cells of the base stations.

### TECHNICAL FIELD

The present invention relates to an information processing method, an information processing apparatus, a wireless communication system, and an information processing program.

### BACKGROUND ART

There are wireless communication systems based on the IEEE 802.11a standard, the IEEE 802.11g standard, and the like, as wireless communication systems using radio waves in a 2.4 GHz band or a 5 GHz band, for example. Here, as a result of using an orthogonal frequency division multiplexing (OFDM) modulation system, the characteristics in a multipath fading environment can be stabilized, and the transmission speed of 54 Mbit/s at maximum can be realized.

Also, in a wireless communication system based on the IEEE 802.11n standard, a transmission speed of 600 Mbit/s at maximum is realized using, in the 2.4 GHz band or 5 GHz band, MIMO (Multiple Input Multiple Output) in which space division multiplexing is performed at the same wireless channel using a plurality of antennas, or a channel bonding technique in which a 40 MHz frequency channel is used, using two 20 MHz frequency channels at the same time.

Also, in a wireless communication system based on the IEEE 802.11ac standard, wireless communication whose speed and efficiency are higher than that of the IEEE 802.11n standard is realized using, in the 5 GHz band, a channel bonding technique in which up to eight 20 MHz frequency channels are used at the same time so as to use them as a frequency channel of 160 MHz at maximum, a multi-user MIMO technique in which different signals are transmitted to a plurality of destinations at the same time using the same wireless channel, or the like (e.g. refer to NPL 1).

### CITATION LIST

### Non Patent Literature

[NPL 1] IEEE Standard for Information technology—Telecommunications and information exchange between systems Local and metropolitan area networks—Specific requirements Part 11: Wireless LAN Medium Access Control (MAC) and Physical Layer (PHY) Specifications, IEEE Std 802.11-2016, December 2016.

### SUMMARY OF THE INVENTION

### Technical Problem

In a wireless communication system, when the intercell interference of a base station is calculated, wireless signal information such as a beacon acquired by the base station may be used. However, there are cases where, when the distance between a terminal and the base station is large, or when using an antenna having high directivity, the wireless signal information acquired by the base station is not necessarily the same as the wireless signal information on the terminal side, and as a result, the radio wave interference between cells cannot be correctly calculated.

The present invention aims at providing an information processing method, an information processing apparatus, a wireless communication system, and an information processing program with which the intercell interference of each of a plurality of base stations that perform wireless communication can be accurately calculated.

### Means for Solving the Problem

An information processing method according to one aspect of the present invention includes: an association step of associating pieces of wireless signal information that are respectively transmitted by a plurality of base stations and are measured at a plurality of measurement positions with cells of the base stations, for each of the measurement positions; and an interference calculation step of calculating interference between cells of the plurality of base stations based on the pieces of wireless signal information associated with the cells of the base stations.

An information processing apparatus according to one aspect of the present invention includes: an associating unit configured to associate pieces of wireless signal information that are respectively transmitted by a plurality of base stations and are measured at a plurality of measurement positions with cells of the base stations, for each of the measurement positions; and an interference calculating unit configured to calculate interference between cells of the plurality of base stations based on the pieces of wireless signal information that were associated with the cells of the base stations by the associating unit.

Also, a wireless communication system according to one aspect of the present invention includes: a plurality of base stations; and an information processing apparatus configured to collect and process pieces of wireless signal information that are respectively transmitted by the plurality of base stations and are measured at a plurality of measurement positions, wherein the information processing apparatus includes: an associating unit configured to associate collected pieces of wireless signal information with cells of the base stations, for each of the measurement positions; and an interference calculating unit configured to calculate interference between cells of the plurality of base stations based on the pieces of wireless signal information that were associated with the cells of the base stations by the associating unit.

### Effects of the Invention

According to the present invention, the intercell interference of each of a plurality of base stations that perform wireless communication can be accurately calculated.

### BRIEF DESCRIPTION OF DRAWINGS

FIG. 1 is a diagram illustrating an exemplary configuration of a wireless communication system according to one embodiment.

FIG. 2 is a diagram schematically illustrating positions of base stations that are arranged inside a coverage area.

FIG. 3 is a diagram schematically illustrating measurement positions at which the intensities of radio waves transmitted by the base stations are measured, inside the coverage area.

FIG. 4 is a functional block diagram illustrating functional units included in an information processing apparatus according to one embodiment has.

FIG. 5 is a diagram illustrating an example of information stored in a storage unit.

FIG. 6 is a diagram illustrating a result obtained by a first processing unit performing first processing (first operation).

FIG. 7 is a diagram illustrating a result obtained by the first processing unit performing first processing (second operation).

FIG. 8 is a flowchart illustrating a specific example of information processing performed by the information processing apparatus along with the first processing (first operation).

FIG. 9 is a flowchart illustrating an exemplary operation when the information processing apparatus performs intercell interference calculation processing.

FIG. 10 is a flowchart illustrating a specific example of information processing performed by the information processing apparatus along with the first processing (second operation).

FIG. 11 is a diagram illustrating an exemplary hardware configuration of the information processing apparatus according to one embodiment.

### DESCRIPTION OF EMBODIMENTS

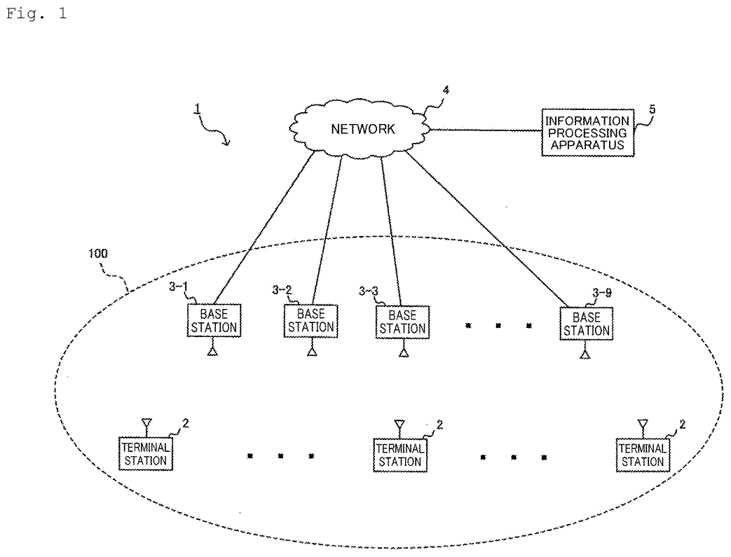

Hereinafter, one embodiment of a wireless communication system will be described using the drawings. FIG. 1 is a diagram illustrating an exemplary configuration of a wireless communication system 1 according to one embodiment. As shown in FIG. 1, for example, the wireless communication system 1 includes nine base stations 3-1 to 3-9 to which a plurality of terminal stations 2 can connect through wireless communication, and an information processing apparatus 5 connected to a network 4. Note that when a base station need not be specified from a plurality of base stations 3-1 to 3-9, the base station is simply denoted as a base station 3 or the like.

The terminal stations 2 are wireless communication terminals, and perform wireless communication with base stations 3. Also, the terminal stations 2 are assumed to have a function as a signal measuring instrument. For example, it is assumed that the terminal station 2 has a signal intensity measuring function of measuring the signal intensity (reception intensity) of a beacon transmitted by a base station 3, a GPS (Global Positioning System) function of acquiring the longitude, latitude, and the like, of the position at which the beacon is received, as a signal intensity measurement position, and a function of acquiring a MAC address (Media Access Control address) included in the beacon.

The base stations 3-1 to 3-9 may be installed such that the cells each overlap a cell of another base station 3, and are connected to the network 4. Here, at least one of the base stations 3-1 to 3-9 can perform wireless communication with a terminal station 2 that is located inside a predetermined area (coverage area) 100. Furthermore, the base stations 3-1 to 3-9 can receive signal intensities measured by each terminal station 2 and the measurement position and MAC addresses that have been acquired by each terminal station 2.

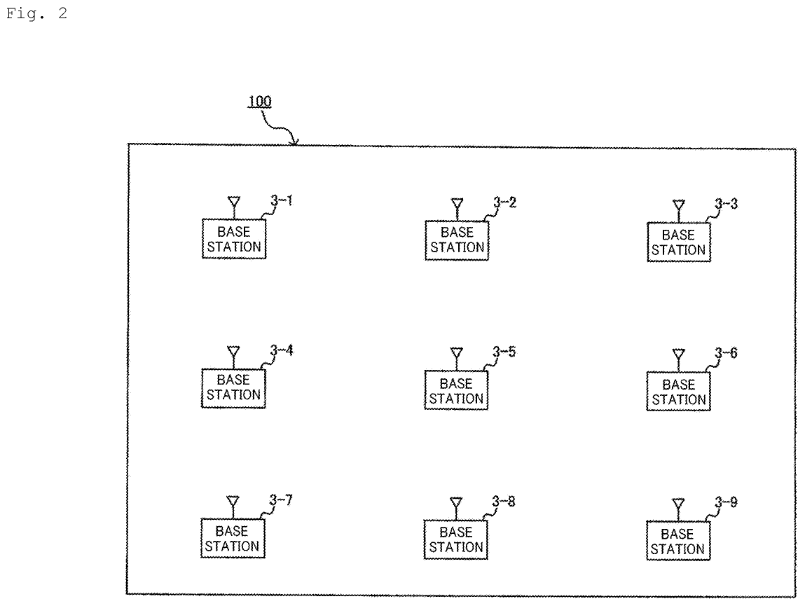

FIG. 2 is a diagram schematically illustrating positions of the base stations 3-1 to 3-9 that are arranged inside the coverage area 100. As shown in FIG. 2, the base stations 3-1 to 3-9 are arranged at predetermined intervals in a predetermined area so as to form the coverage area 100. Here, it is assumed that the base stations 3-1 to 3-9 may not have the same performance such as transmission power, and may not have the same shape (antenna directivity) and size of their cells.

Also, it is assumed that the positions at which the base stations 3-1 to 3-9 are installed are stored in the information processing apparatus 5 as base station position information including the longitude and latitude, for example. Also, information in which a base station 3 is associated with base station position information of the base station 3 is denoted as base station specification information (base station arrangement information).

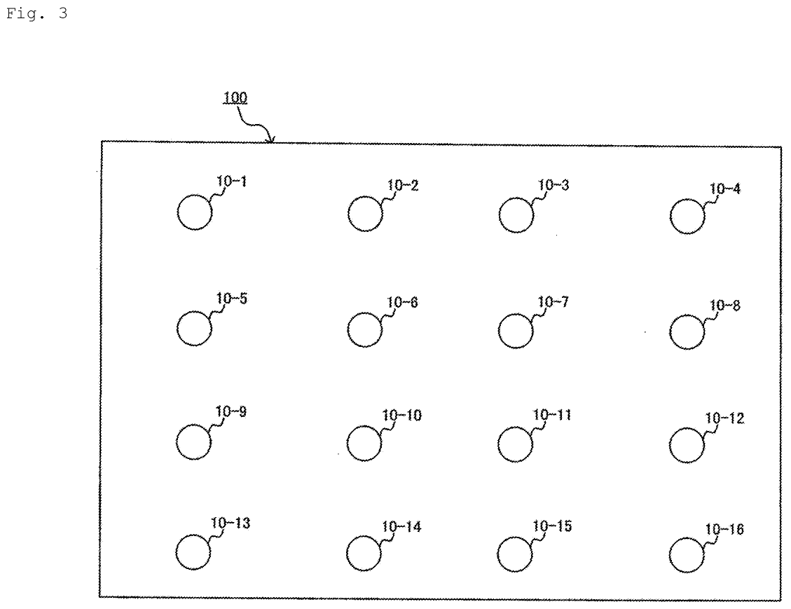

FIG. 3 is a diagram schematically illustrating measurement positions at which the intensities 10-1 to 10-16 of radio waves transmitted by the base stations 3-1 to 3-9 are measured, inside the coverage area 100. As shown in FIG. 3, the terminal stations 2 receive beacons transmitted from the base stations 3 at 16 measurement positions 10-1 to 10-16 that are located at predetermined intervals inside the coverage area 100, for example. Also, the terminal stations 2 transmit the measured signal intensities, and measurement positions and MAC addresses that are acquired to base stations 3 that are connectable. Note that the positions of the measurement positions 10-1 to 10-16 are not specifically limited as long as being inside the coverage area 100. Also, an apparatus that transmits measured signal intensities, and measurement positions and MAC addresses that are acquired to a base station 3 that is connectable is not limited to a terminal station 2, and may also be another apparatus.

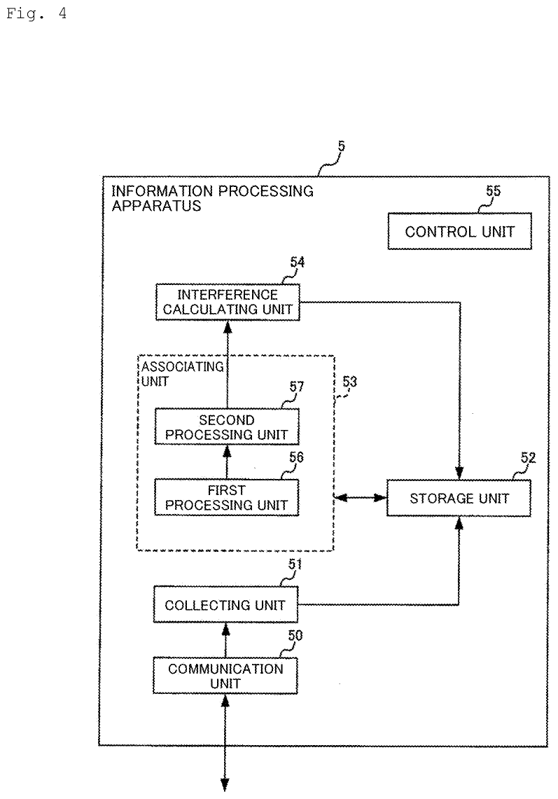

Next, the functional units included in the information processing apparatus 5 will be described. FIG. 4 is a functional block diagram illustrating the functional units included in the information processing apparatus 5 according to one embodiment. As shown in FIG. 4, the information processing apparatus 5 includes a communication unit 50, a collecting unit 51, a storage unit 52, an associating unit 53, an interference calculating unit 54, and a control unit 55, for example.

Also, the information processing apparatus 5 has a function of collecting pieces of wireless signal information (beacons and the like) that are transmitted from the plurality of base station 3, respectively, and measured at the plurality of measurement positions 10, and accurately calculating the intercell interference of each of the plurality of base station 3.

Specifically, the communication unit 50 is a communication interface for performing communication with the base stations 3-1 to 3-9 via the network 4.

The collecting unit 51 collects signal intensities (reception intensities), measurement positions, and MAC addresses (beacon MAC address) that the base stations 3-1 to 3-9 have received from the terminal stations 2 via the communication unit 50, and stores them in the storage unit 52.

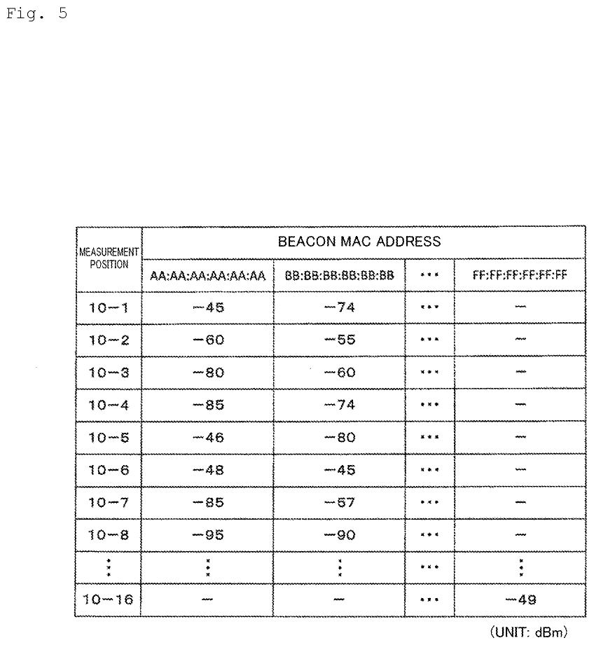

FIG. 5 is a diagram illustrating an example of information stored in the storage unit 52. As shown in FIG. 5, the storage unit 52 stores the signal intensities (reception intensities), the measurement positions, and MAC addresses (beacon MAC address) that are collected by the collecting unit 51.

The associating unit 53 (FIG. 4) includes a first processing unit 56 and a second processing unit 57, performs associating processing using the information stored in the storage unit 52, and output the processing result to the interference calculating unit 54. For example, the associating unit 53 performs processing for associating the pieces of wireless signal information that are transmitted from the plurality of base stations 3 and are measured at the plurality of measurement positions 10 with the cells of the base stations 3, with respect to each measurement position 10.

Specifically, the first processing unit 56 performs first processing (first operation) for associating measurement positions 10 at which wireless signal information of a reception intensity of a predetermined value or more is obtained with the cells of base stations 3 that have transmitted the respective pieces of wireless signal information, and outputs the processing result to the second processing unit 57.

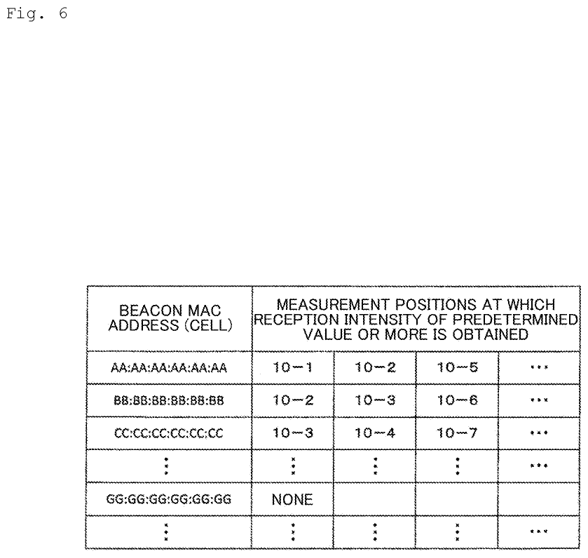

FIG. 6 is a diagram illustrating a result obtained by the first processing unit 56 performing the first processing (first operation). As shown in FIG. 6, the first processing unit 56 associates measurement positions 10 at which wireless signal information of a reception intensity of the predetermined value or more is obtained to the cells of base stations 3 that have transmitted the respective pieces of wireless signal information, in the first processing (first operation). Here, the beacon MAC address of a base station 3 corresponds to the cell of the base station 3.

Also, the first processing unit 56 performs processing, with respect to each of the measurement positions 10, for associating the cell of a base station 3 regarding which the reception intensity is the predetermined value or more and is largest with the measurement position 10, as first processing (second operation), and may output the processing result to the second processing unit 57.

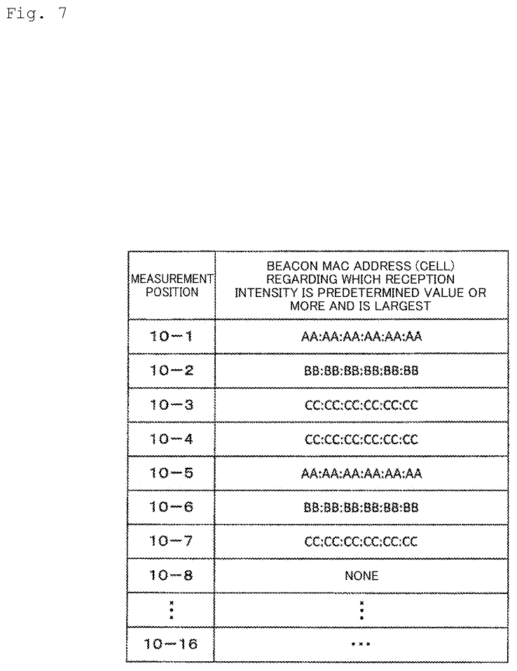

FIG. 7 is a diagram illustrating a result obtained by the first processing unit 56 performing the first processing (second operation). As shown in FIG. 7, the first processing unit 56 associates, with respect to each of the measurement positions 10, the cell of a base station 3 regarding which the reception intensity is the predetermined value or more and is largest with the measurement position 10, in the first processing (second operation). Here as well, the beacon MAC address of a base station 3 corresponds to the cell of the base station 3.

The second processing unit 57 performs, with respect to the cell of a base station 3 regarding which the number of measurement positions 10 associated by the first processing unit 56 is 0, second processing for associating a measurement position 10 at which the reception intensity of the wireless signal information is highest, and outputs the processing result to the interference calculating unit 54. Here, the information processing apparatus 5 performs association regarding the measurement positions 10, such that duplication is permitted.

The interference calculating unit 54 calculates interference between the cells of the plurality of base stations 3 based on the wireless signal information associated with the cells of the base stations 3, and stores the calculation result in the storage unit 52. Specifically, the interference calculating unit 54 calculates, for the cell of each base station 3, the intercell interference (intercell interference calculation processing), using the reception intensity at a measurement position 10 at which the intensity of interference from the cells of other base stations 3 is highest, and stores the calculation result in the storage unit 52.

Also, the interference calculating unit 54 may calculate the intercell interference using reception intensity information of desired wave/interference wave at each measurement position 10.

The control unit 55 control the units that constitute the information processing apparatus 5. For example, the control unit 55 performs control such that, based on the information collected by the collecting unit 51, the associating unit 53 performs processing, and the interference calculating unit 54 calculates intercell interference.

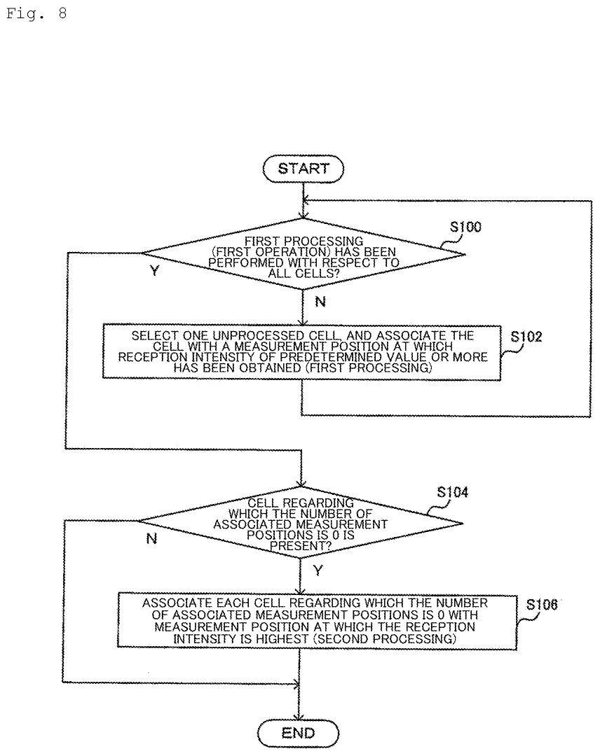

Next, a specific example of information processing performed by the information processing apparatus 5 will be described using FIGS. 8 to 10. FIG. 8 is a flowchart illustrating the specific example of the information processing performed by the information processing apparatus 5 along with the first processing (first operation).

As shown in FIG. 8, the information processing apparatus 5 determines whether or not the first processing (first operation) has been performed with respect to the cells of all of the base stations 3 (step S100). The information processing apparatus 5 advances the processing to step S102, if it is determined that the first processing (first operation) has not been performed with respect to all of the cells (step S100: No), and advances the processing to step S104, if it is determined that the first processing (first operation) has been performed with respect to all of the cells (step S100: Yes).

In the processing in step S102, the information processing apparatus 5 selects one cell with respect to which processing has not been performed, and associates the cell with a measurement position 10 at which a reception intensity of the predetermined value or more has been obtained (first processing: see FIG. 6), and returns the processing to step S100.

In the processing in step S104, the information processing apparatus 5 determines whether or not a cell regarding which the number of associated measurement positions 10 is 0 is present. The information processing apparatus 5 advances the processing to step S106, if it is determined that a cell regarding which the number of associated measurement positions 10 is 0 is present (step S104: Yes), and ends the processing, if it is determined that a cell regarding which the number of associated measurement positions 10 is 0 is not present (step S104: No).

In the processing in step S106, the information processing apparatus 5 associates each of the cells regarding which the number of associated measurement positions 10 is 0 with a measurement position 10 at which the reception intensity is highest (second processing). For example, as shown in FIG. 6, regarding the cell whose beacon MAC address is GG:GG:GG:GG:GG:GG, the measurement position 10 at which a reception intensity of a predetermined value or more is obtained is not present, and therefore the information processing apparatus 5 associates the cell with a measurement position 10 at which the reception intensity is highest, although being less than the predetermined value, based on the information stored in the storage unit 52.

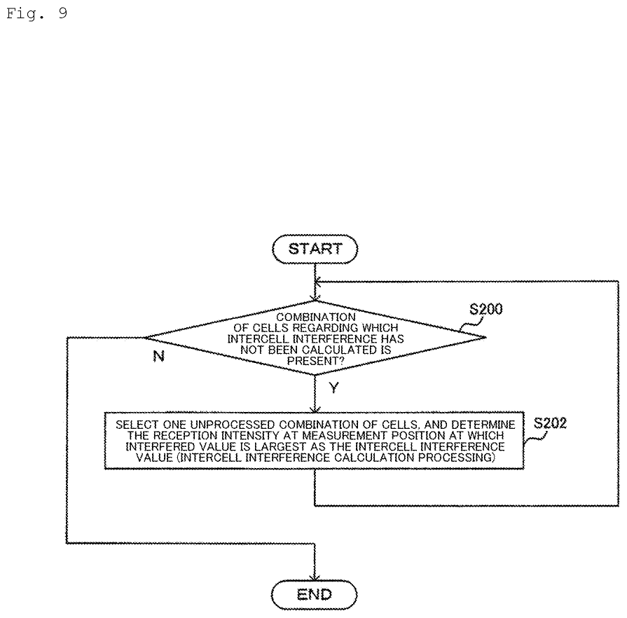

FIG. 9 is a flowchart illustrating an exemplary operation when the information processing apparatus 5 performs an intercell interference calculation processing. As shown in FIG. 9, the information processing apparatus 5 determines, with respect to the plurality of base stations 3, whether or not a combination of cells regarding which intercell interference has not been calculated is present (step S200). The information processing apparatus 5 advances the processing to step S202, if it is determined that a combination of cells regarding which intercell interference has not been calculated is present (step S200: Yes), and ends the processing, if it is determined that a combination of cells regarding which intercell interference has not been calculated is not present (step S200: No).

In the processing in step S202, the information processing apparatus 5 selects one unprocessed combination of cells, and determines the reception intensity at a measurement position 10 at which a value indicating the interfered amount is largest as the intercell interference value (intercell interference calculation processing).

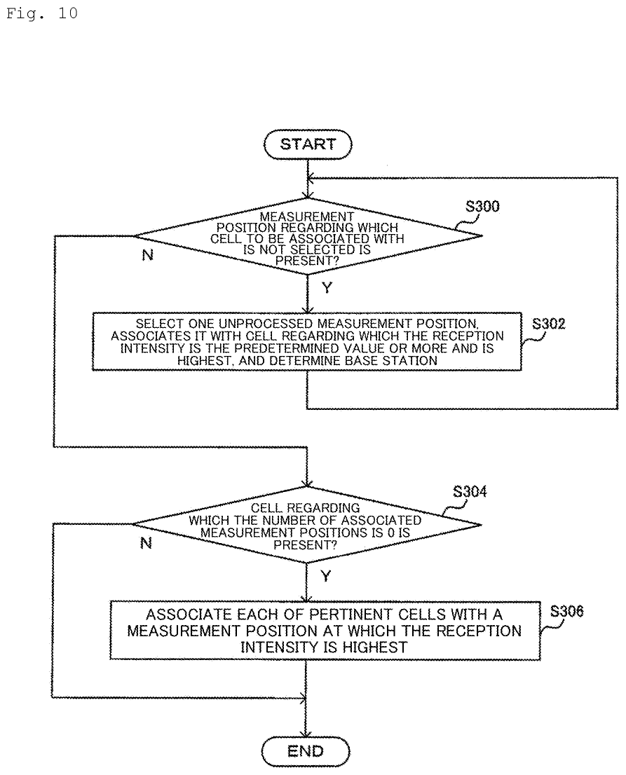

Next, a case where the first processing unit 56 performs the first processing (second operation) will be described. FIG. 10 is a flowchart illustrating a specific example of the information processing performed by the information processing apparatus 5 along with the first processing (second operation).

As shown in FIG. 10, information processing apparatus 5 determines whether or not a measurement position 10 regarding which the cell to be associated with is not selected is present (step S300). The information processing apparatus 5 advances the processing to step S302, if it is determined that a measurement position 10 regarding which the cell to be associated with is not selected is present (step S300: Yes), and advances the processing to step S304, if it is determined that a measurement position 10 regarding which the cell to be associated with is not selected is not present (step S300: No).

In the processing in step S302, the information processing apparatus 5 selects one unprocessed measurement position 10, associates it with a cell regarding which the reception intensity is the predetermined value or more and is highest, and determines the base station 3 that forms the cell as the base station 3 that covers the measurement position 10 (first processing: see FIG. 7), and returns the processing to step S300.

In the processing in step S304, the information processing apparatus 5 determines whether or not a cell regarding which the number of associated measurement positions 10 is 0 is present. The information processing apparatus 5 advances the processing to step S306, if it is determined that a cell regarding which the number of associated measurement positions 10 is 0 is present (step S304: Yes), and ends the processing, if it is determined that a cell regarding which the number of associated measurement positions 10 is 0 is not present (step S304: No).

In the processing in step S306, the information processing apparatus 5 associates each of the cells regarding which the number of associated measurement positions 10 is 0 with a measurement position 10 at which the reception intensity is highest. Note that, as shown in FIG. 7, at a measurement position 10-8, a cell regarding which the reception intensity is the predetermined value or more is not present. Therefore, the processing in step S306 may also be such that information processing apparatus 5 associates the measurement position 10-8 with a cell regarding which the reception intensity is highest, although being less than the predetermined value, based on the information stored in the storage unit 52.

Note that, in the above description, it is assumed that the beacon MAC address corresponds to one of the base stations 3 in the base station arrangement information, but the operation of the wireless communication system 1 is not limited to this case. For example, when a beacon MAC address of a base station that is not arranged inside the coverage area 100 is detected in the coverage area 100, the information processing apparatus 5 makes a distinction of the beacon MAC address of that base station.

In this case, the information processing apparatus 5 identifies the base station based on another information included in the beacon MAC address (e.g., manufacturer information for specifying the manufacturer of the base station), performance information indicating the performance (capability) of the base station that is included in the wireless signal information, or the like.

As described above, the wireless communication system 1 according to the embodiment associates pieces of wireless signal information that are transmitted by a plurality of base stations 3 and are measured at a plurality of measurement positions 10 with cells of the base stations 3, for each of the measurement positions 10, calculates the interference between cells of the plurality of base stations 3 based on the pieces of wireless signal information associated with the cells of the base stations 3, and therefore the intercell interference of each of the plurality of base stations 3 can be accurately calculated. Here, the intercell interference on the terminal station 2 side is also considered.

Note that, with respect to the functional units included in the terminal stations 2, the base stations 3, and the information processing apparatus 5, a portion or the entirety thereof, in each of the apparatuses, may be constituted by hardware such as a PLD (Programmable Logic Device) or an FPGA (Field Programmable Gate Array), or may be constituted as a program to be executed by a processor such as a CPU.

For example, the information processing apparatus 5 according to the present invention can be realized by using a computer and a program, and the program can be recorded in a storage medium, or can also be provided through a network.

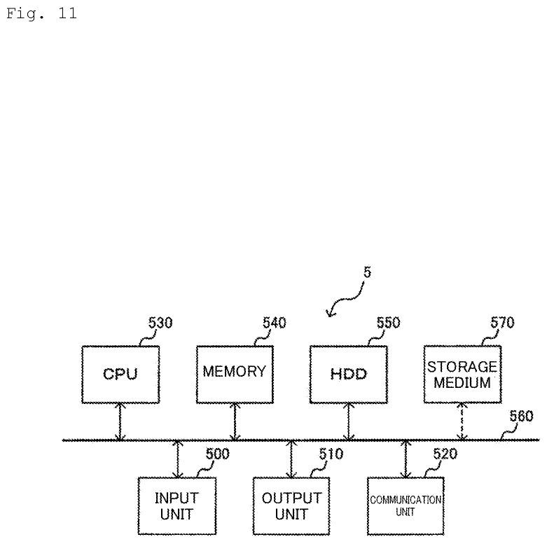

FIG. 11 is a diagram illustrating an exemplary hardware configuration of the information processing apparatus 5 according to one embodiment. As shown in FIG. 11, the information processing apparatus 5 in which an input unit 500, an output unit 510, a communication unit 520, a CPU 530, a memory 540, and an HDD 550 are connected via a bus 560 has functions as a computer, for example. Also, the information processing apparatus 5 is configured to be able to receive input of data from and output data to a computer-readable storage medium 570.

The input unit 500 is a keyboard, a mouse, and the like. The output unit 510 is a display device such as a display, for example. The communication unit 520 is a wired network interface, for example.

The CPU 530 controls the units that constitute the information processing apparatus 5, and performs predetermined processing and the like. The memory 540 and the HDD 550 constitute a storage unit that stores data. In particular, the memory 540 store pieces of data used for the processing described above. The storage medium 570 is configured to be able to store an information processing program for execution of functions that the information processing apparatus 5 has. Note that the architecture of the information processing apparatus 5 is not limited to the example shown in FIG. 11.

That is, the “computer” mentioned here includes an OS and hardware such as peripheral devices. Also, the “computer-readable storage medium” is a storage device such as a portable medium such as a flexible disk, a magneto-optical disk, a ROM, or a CD-ROM.

Furthermore, the “computer-readable storage medium” may include a medium that dynamically retains a program in a short period of time, such as communication wire that is used when transmitting a program through a network such as the Internet or a communication line such as a telephone line, or a medium that retains a program in a certain period of time, such as a volatile memory in a computer that serves as a server or a client when transmitting the program.

As described above, although an embodiment of the present invention has been described with reference to the drawings, the embodiment described above is merely an example, and it will be evident that the present invention is not limited to the embodiment described above. Therefore, addition, omission, or replacement of the constituent elements, and another modification that do not depart from the technical concepts and scope of the invention may be performed.

### REFERENCE SIGNS LIST

1 Wireless communication system
2 Terminal station
3-1 to 3-9 Base station
4 Network
5 Information processing apparatus
10-1 to 10-16 Measurement position
50 Communication unit
51 Collecting unit
52 Storage unit
53 Associating unit
54 Interference calculating unit
55 Control unit
56 First processing unit
57 Second processing unit
100 Coverage area
500 Input unit
510 Output unit
520 Communication unit
530 CPU
540 Memory
550 HDD
560 Bus
570 Storage medium

1. An information processing method comprising:
an association step of associating pieces of wireless signal information that are respectively transmitted by a plurality of base stations and are measured at a plurality of measurement positions with cells of the base stations, for each of the measurement positions; and
an interference calculation step of calculating interference between cells of the plurality of base stations based on the pieces of wireless signal information associated with the cells of the base stations.

2. The information processing method according to claim 1,
wherein the association step includes:
a first processing step of associating a cell of each base station with measurement positions at which wireless signal information of a reception intensity of a predetermined value or more is obtained; and
a second processing step of associating a cell of a base station regarding which the number of associated measurement positions is 0 with a measurement position at which the reception intensity of wireless signal information is highest.

3. The information processing method according to claim 1,
wherein the association step includes:
a first processing step of associating each measurement position with the cell of a base station regarding which the reception intensity is a predetermined value or more and is largest; and
a second processing step of associating the cell of a base station regarding which the number of associated measurement positions is 0 with a measurement position at which the reception intensity of wireless signal information is highest.

4. The information processing method according to claim 1,
wherein, in in the interference calculation step, intercell interference is calculated using the reception intensity at a measurement position at which power of interference by a base station that is an interference source is highest, among pieces of wireless signal information associated with cells of base stations.

5. An information processing apparatus comprising:
an associating unit configured to associate pieces of wireless signal information that are respectively transmitted by a plurality of base stations and are measured at a plurality of measurement positions with cells of the base stations, for each of the measurement positions; and
an interference calculating unit configured to calculate interference between cells of the plurality of base stations based on the pieces of wireless signal information that were associated with the cells of the base stations by the associating unit.

6. A wireless communication system comprising:
a plurality of base stations; and
an information processing apparatus configured to collect and process pieces of wireless signal information that are respectively transmitted by the plurality of base stations and are measured at a plurality of measurement positions,
wherein the information processing apparatus includes:
an associating unit configured to associate collected pieces of wireless signal information with cells of the base stations, for each of the measurement positions; and
an interference calculating unit configured to calculate interference between cells of the plurality of base stations based on the pieces of wireless signal information that were associated with the cells of the base stations by the associating unit.

7. A non-transitory computer-readable storage medium storing an information processing program for causing a computer to function as the units of the information processing apparatus according to claim 5.
